(19) United States
(12) Patent Application Publication
(10) Pub. No.: US 2018/0173009 A1
(43) Pub. Date: Jun. 21, 2018

(54) OPTICAL DEVICE FOR OFF-AXIS VIEWING

(71) Applicants: Wayne H. Knox, Pittsford, NY (US); Leonard A. Zheleznyak, Rochester, NY (US)

(72) Inventors: Wayne H. Knox, Pittsford, NY (US); Leonard A. Zheleznyak, Rochester, NY (US)

(73) Assignee: University of Rochester, Rochester, NY (US)

(21) Appl. No.: 15/577,060

(22) PCT Filed: May 26, 2016
(86) PCT No.: PCT/US16/34340

§ 371 Date: Nov. 27, 2017

Related U.S. Application Data
(60) Provisional application No. 62/168,282, filed on May 29, 2015.

(51) Int. Cl. G02C 7/04

(52) U.S. Cl. CPC G02C 7/049; G02C 2202/20; G02C 2202/10; G02C 2202/06

(57) ABSTRACT

An optical device for off-axis viewing includes a contact lens adapted for human eye wear. The contact lens includes a diffraction grating written into or on the contact lens. A peripheral light from a peripheral light source is diffracted by the diffraction grating so as to appear at about a same location as light from an ambient scene substantially in a direction of a central field of view. A wearer of the optical device for off-axis viewing sees simultaneously the peripheral light and the light from an ambient scene as superimposed at least in part over each other. A device-less method for correcting light direction from an ambient light source to a retina of a diseased or injured eye, and a remedial contact lens method for correcting light direction from an ambient light source to a retina of a diseased or injured eye are also described.

### CROSS-REFERENCE TO RELATED APPLICATIONS

This application claims priority to and the benefit of co-pending U.S. provisional patent application Ser. No. 62/168,282, OPTICAL DEVICE FOR OFF-AXIS VIEWING, filed May 29, 2015, which application is incorporated herein by reference in its entirety.

### FIELD OF THE APPLICATION

The application relates to head-up viewing and particularly to devices, products, and techniques of head-up viewing and to use of head-up viewing devices, products, and techniques in corrective vision applications including partial vision restoration.

### BACKGROUND

Google Glass™ is a well-known device which adds a computer display to a person's forward vision, typically associated with eye glasses or an eye glass like mount. A small projector is provided as part of the Google Glass™ device which generates light that is added to the person's field of view by an optical beamsplitter. For example, FIG. 1 shows a drawing illustrating one eye glass like embodiment of the Google Glass™ device from <https://www.google.com/glass/start/what-it-does/>.

Turning to U.S. Patent Application Publication No. 2013/0070338 assigned to Google™, FIG. 2 shows FIG. 2 of the '338 application which shows a drawing of the Google Glass™ device beamsplitter.

Prior art head-up displays add readable information to a person's forward vision typically by projecting text and/or images onto a windshield or windscreen. Such head-up displays appear in a wide variety of aviation and now increasingly, automotive applications. Google Glass™ is a type of head-up display. Google Glass™, while a type of head-up display, brought the concept of head-up display to a person's forward vision without need for an intervening relatively large transparent plate (e.g. fighter aircraft head-up displays) or a windshield surface.

### SUMMARY

According to one aspect, an optical device for off-axis viewing includes a contact lens adapted for human eye wear. The contact lens includes a diffraction grating written into or on the contact lens. A peripheral light from a peripheral light source is diffracted by the diffraction grating so as to appear at about a same location as light from an ambient scene substantially in a direction of a central field of view. A wearer of the optical device for off-axis viewing sees simultaneously, the peripheral light and the light from an ambient scene as superimposed, at least in part, over each other.

In one embodiment, the peripheral light from a peripheral light source includes a substantially monochromatic light.

In another embodiment, the peripheral light from a peripheral light source includes a light of at least two or more different colors.

In yet another embodiment the optical device further includes a color multiplexing technique to combine different colors of the peripheral light into a color corrected image.

In yet another embodiment, the color multiplexing technique includes at least two different color light generators spaced apart from each other.

In yet another embodiment, the color multiplexing technique further includes disposed between the peripheral light source and the contact lens a second corrective diffraction grating and lens.

In yet another embodiment, an area of the diffraction grating written on or into the contact lens determines an intensity of the peripheral light directed onto a retina of the eye.

In yet another embodiment, a diffraction grating efficiency of the diffraction grating written on or into the contact lens determines an intensity of the peripheral light directed onto a retina of the eye.

According to another aspect, a device-less method for correcting light direction from an ambient light source to a retina of a diseased or injured eye includes: providing a laser scanning system configured to write a diffraction grating on or into a cornea of a human; and writing a diffraction grating of grating length defined by a number of written grating lines, grating width defined by a laser scanning distance, and a diffraction grating wavelength dependence defined by a grating line spacing on or in a cornea of the human eye.

In one embodiment, the step of writing includes writing a diffraction grating directly into the cornea by use of a pulsed laser micromachining system.

In yet another embodiment, the pulsed laser micromachining includes about 400 nm wavelength high repetition rate about 100 fs width pulses.

In yet another embodiment, the eye includes an eye affected by an eye disease or injury to the eye, and the diffraction grating redirects an ambient light received by the eye to a another part of a retina of the eye to mitigate symptoms of the eye disease or injury.

In yet another embodiment, the ambient light that would fall upon a blind region of the retina is redirected by the diffraction grating to a region of peripheral vision region of the retina, providing a partial vision restoration.

In yet another embodiment, the diffraction grating provides myopic central vision correction or a hyperopic shift correction across a peripheral area of the retina.

In yet another embodiment, the diffraction grating causes the ambient light entering a strabismic or misaligned eye to fall about on a central region of the or in the fovea region.

According to yet another aspect, a remedial contact lens method for correcting light direction from an ambient light source to a retina of a diseased or injured eye includes: providing a laser configured to write a diffraction grating on or into a contact lens of human eye, the contact lens having a corrective physical and optical shape tailored to the eye; and writing a diffraction grating of grating length defined by a number of written grating lines, grating width defined by a laser scanning distance, and diffraction grating wavelength dependence defined by a grating line spacing on or into a the contact lens; and wearing the contact lens including the diffraction grating.

In one embodiment, the step of writing includes writing a diffraction grating directly into the contact lens by use of femtosecond laser micromachining.

In another embodiment, the step of writing includes about 400 nm wavelength high repetition rate about 100 fs width pulses.

In yet another embodiment, the human eye includes an eye affected by an eye disease or injury to the eye, and the diffraction grating redirects an ambient light received by the eye to a another part of a retina of the eye to mitigate symptoms of the eye disease or injury.

In yet another embodiment, the ambient light from a blind region of the retina is redirected by the diffraction grating to a region of at least partial vision in what would otherwise in an absence of the diffraction grating, be a peripheral vision region of the retina.

In yet another embodiment, the diffraction grating provides a myopic central vision correction or a hyperopic shift correction across a peripheral area of the retina.

In yet another embodiment, the diffraction grating causes the ambient light entering a strabismic or misaligned eye to fall about on a central region of the retina or in the fovea region.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1 shows a drawing illustrating an eyeglass like embodiment of the Google Glass™ device;

FIG. 2 shows a drawing of the Google Glass™ device beamsplitter;

FIG. 3 shows a drawing illustrating multiple diffracted orders of a diffraction grating;

FIG. 4A shows a drawing of an exemplary implementation of a diffraction grating in a contact lens;

FIG. 4B is a graph showing a distribution of diffraction angle for various values of incident angle and exemplary line spacing for a wavelength of 0.5 micrometers;

FIG. 4C is a graph showing the angle of diffraction as a function of incident angle for 0.7 micrometer line spacing and 0.5 micrometer wavelength;

FIG. 5 shows another embodiment of a contact lens that has a diffraction grating written into it;

FIG. 6 shows a drawing illustrating an exemplary contact lens with a reduced size diffraction grating;

FIG. 7A is a drawing illustrating how the light from the ambient scene is diffracted into the peripheral vision zone;

FIG. 7B shows a graph of threshold incident angle to avoid pupil entry of a 0th order beam as a function of incident beam diameter and pupil size;

FIG. 8 shows a drawing illustrating an exemplary angularly multiplexed light source that uses three separate differently colored objects;

FIG. 9 shows a drawing illustrating an exemplary white source object which is angularly multiplexed by inclusion of a diffraction grating into a relay lens system;

FIG. 10 shows one exemplary embodiment of an optical device for off-axis viewing based on a conventional thin diffraction grating placed near the cornea of an eye;

FIG. 11 is a drawing illustrating an exemplary diffraction grating contemplated as written directly into the cornea of the eye;

FIG. 12 shows a drawing that illustrates the use of a first order diffraction grating written into an exemplary custom contact lens to provide partial vision recovery for a patient suffering from macular degeneration;

FIG. 13A shows a drawing illustrating a myopic eye with a central foveal correction that is typically hyperopic in the peripheral retina;

FIG. 13B shows a drawing illustrating a customized contact lens that provides vision correction across the visual field, in the central fovea as well as the peripheral eye retina;

FIG. 14A shows a drawing of a healthy eye and a strabismic (misaligned eye) illustrating how in the misaligned eye, the image falls on the peripheral retina; and

FIG. 14B shows a drawing of a healthy eye and a strabismic (misaligned eye) illustrating an image corrected by a contact lens having an integral diffraction grating.

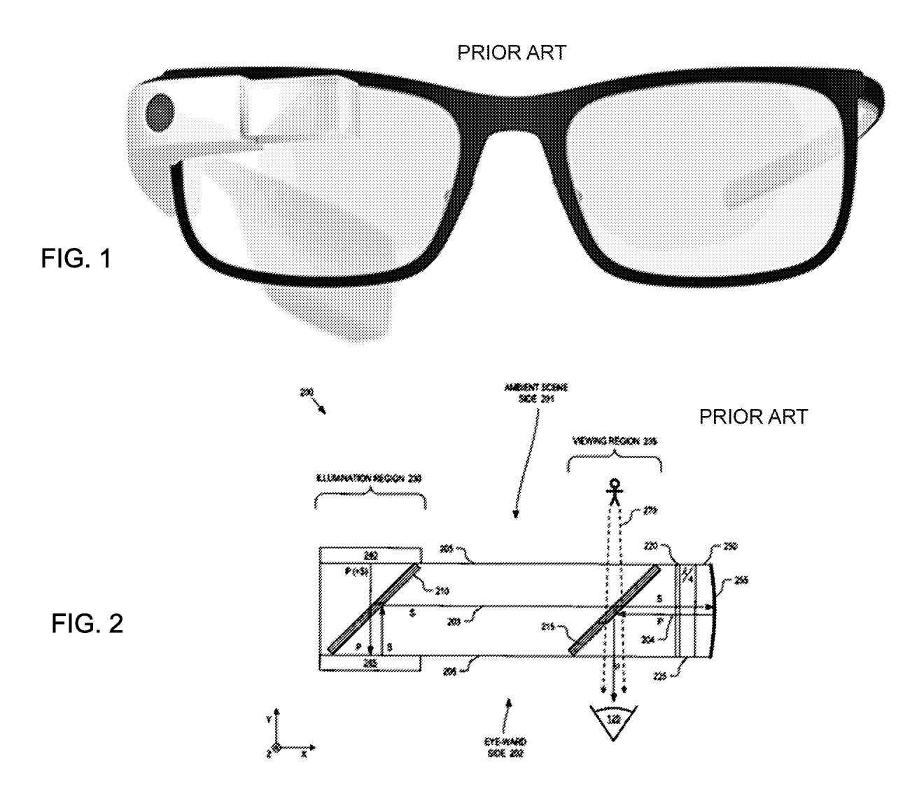

### DETAILED DESCRIPTION

In the description, other than the bolded paragraph numbers, non-bolded square brackets (“[ ]”) refer to the citations listed hereinbelow under references.

As discussed hereinabove, for head-up display applications a direct forward view of an ambient scene is provided in combination with another display by using beam splitters or by allowing a viewer to occupy part of the visual field.

In this application, a new type of head-up display based on a diffraction grating is described. The new device can be written inside a customized contact lens and placed onto the surface of the eye. In medical applications, such as, for example, when used to enhance or to repair sight for a diseased eye, a diffraction grating could be directly written into the eye. A new kind of viewer that can be provided by using an optical device in contact with the eye (e.g. a contact lens) or directly written into the eye in the form of a diffraction grating is described in detail herein below. This new type of head-up display diffractive grating based device allows an off-axis scene to be directly projected onto the retina in a flexible manner, so that the visual field is not interrupted and so that no beam splitters are required. A full field of vision can also be provided.

Before the detailed description of the various exemplary embodiments of the optical device for off-axis viewing, diffraction gratings are first briefly described or reviewed.

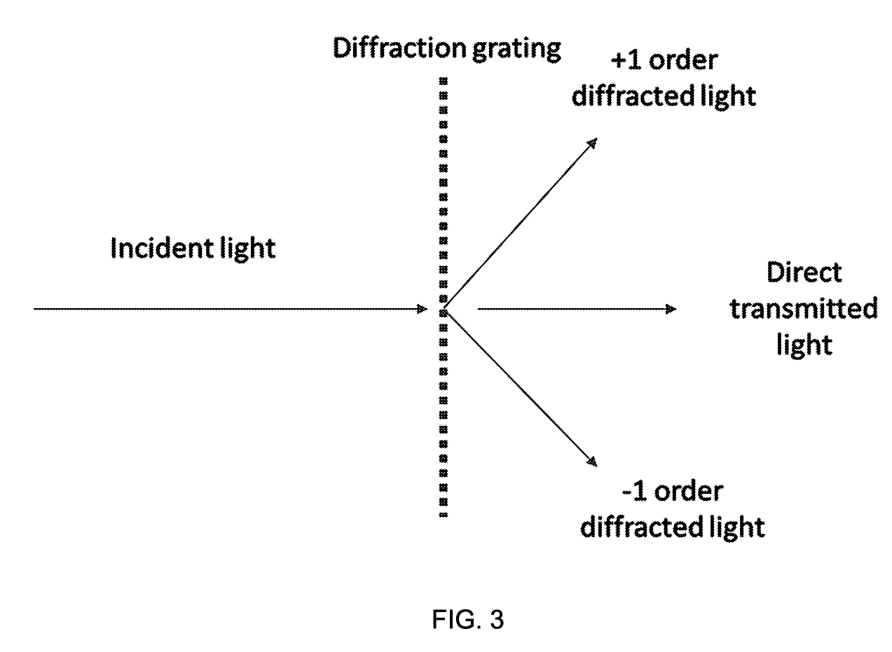

FIG. 3 shows a drawing illustrating multiple diffracted orders of a diffraction grating. The diffraction grating includes a series of small lines with a spacing of D. When light is incident on the diffraction grating, it is split into several beams. One of the beams propagates with diminished intensity in the same direction as the incident beam (called the “zero order”). Other diffracted beams propagate at an angle to the axis as described by the following equation sin(θ)=m*λ/D, where θ is the angle of each beam, λ is the wavelength and m is a series of integers m=0, m=±1, m=±2, etc. . . . .

In one embodiment of the new device for off-axis viewing, a contact lens can be placed onto the eye of a normal contact lens wearer. The contact lens includes a diffraction grating written into or onto the surface of the contact lens by any suitable method. If the wearer has already been fitted for contact lenses, then the gratings would typically be written into contact lenses already having the normal corrective prescription for that person. In the case of an emmetropic user, the diffraction grating can be written into a plano (zero power) contact lens.

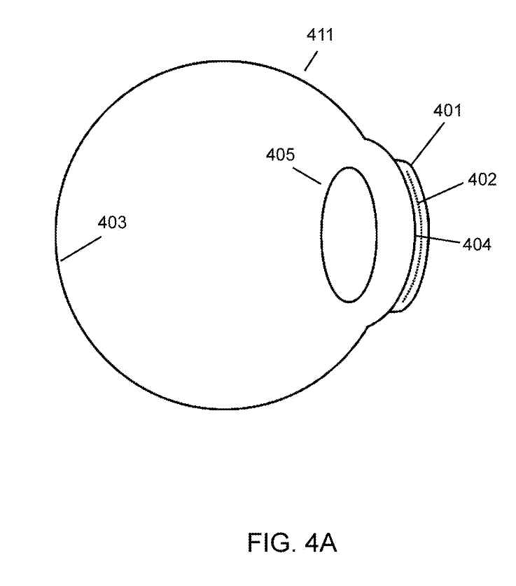

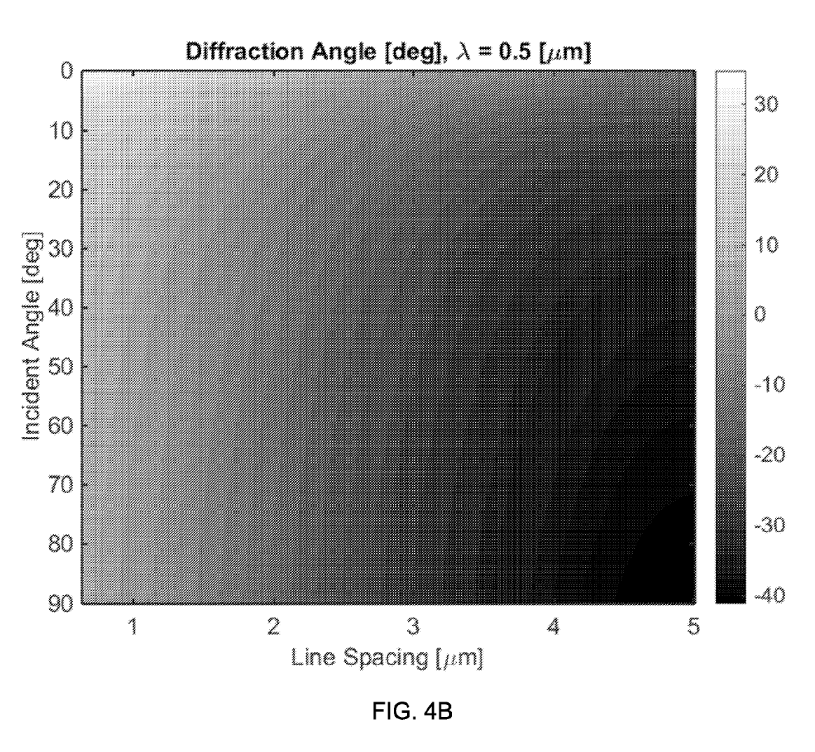

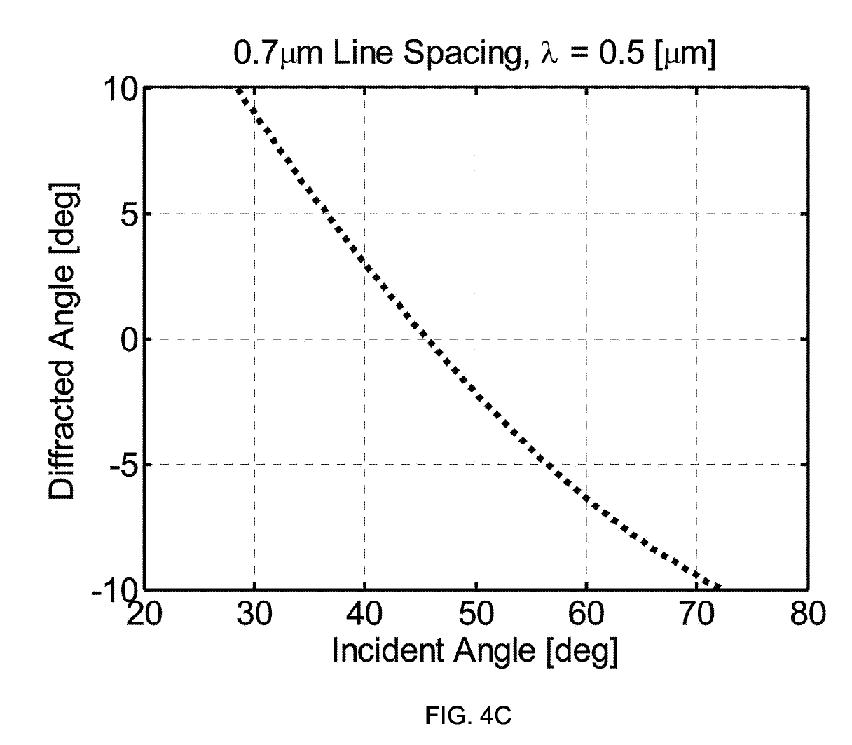

FIG. 4A shows a drawing of an exemplary implementation of a diffraction grating 402 in a contact lens 401, with the contact lens placed on the cornea 404 of the eye of the user in the normal way that a person wears a contact lens. As with normal human vision, light received through the cornea is focused by lens 405 on the retina 403 of the eye. The functioning of the grating allows light that is incident at an oblique angle to be presented to the eye such that it is incident at normal incidence, appearing to come from the center of the visual field. This is accomplished without interruption of the primary visual field. For instance, using a grating spacing of about 0.7 micrometers, about in the center of the visual sensitivity around 500 nm, the viewing angle would be about 45 degrees. With a grating spacing of about 0.6 micrometers, the viewing angle is about 56 degrees, which is well into the peripheral vision zone for human vision.

Returning to the operation of diffraction gratings, the angle of diffraction (θ_{diffracted}) of the grating is dependent upon the wavelength (λ), grating line spacing (D) and the angle of incidence (θ_{incident}), as shown in the equation below:

$${θ}_{diffracted} = arcsin ( \frac{m λ}{D} - sin {θ}_{incident} )$$

The graph of FIG. 4B shows a distribution of diffraction angle for various values of incident angle and exemplary line spacing for wavelength of 0.5 micrometers. As shown in FIG. 4b below, for the diffracted angle to stay within the foveal region of central vision (+/−2 degrees), the incident angle has a range of several degrees for a given line spacing.

FIG. 4C is a graph showing the angle of diffraction as a function of incident angle for 0.7 micrometer line spacing and 0.5 micrometer wavelength. In the case of 0.5 micrometer wavelength and 0.7 micrometer line spacing, the projected image will remain within central vision (i.e. approximately ±2 degrees of visual field) with an incident angle ranging from approximately 45±4 degrees, as shown by the graph of FIG. 4C.

In some embodiments, the diffraction grating can be included into the contact lens material by a technique of femtosecond laser micromachining Femtosecond laser micromachining, for example, has been shown to produce long-lasting index of refraction changes and diffraction gratings [2] and cylindrical lenses [3] in hydrogel polymers that are typically used for soft contact lens manufacturing.

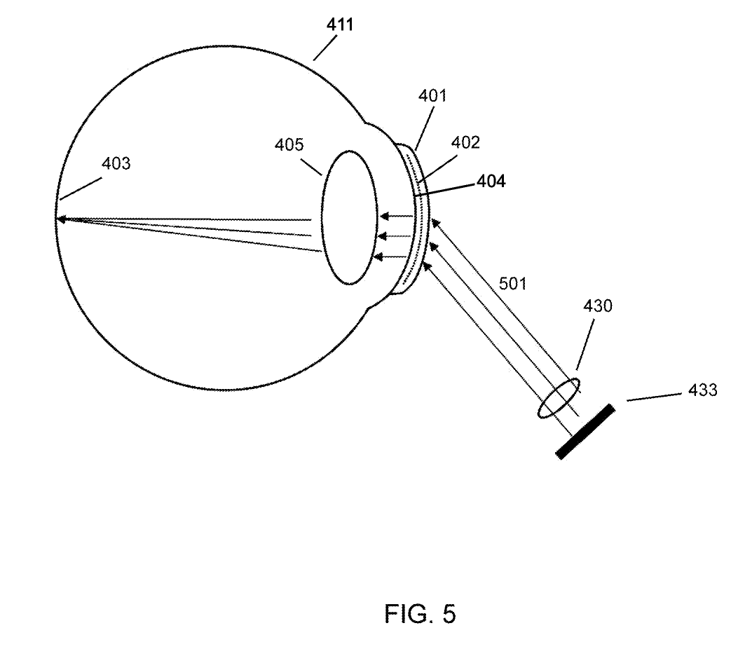

FIG. 5 also shows a contact lens 401 that has a diffraction grating 402 written into it. The contact lens 401 diffracts the light 501 incident from a source object 433 and imaging lens 430 so that the light 501 appears to be coming from the center of the visual field, however the light 501 is actually located well into the peripheral vision region as illustrated by the ray diagram of FIG. 5.

The source object 433 can, for example, be a LED-illuminated LCD image forming device. Or, for example, the source object 433 can be another laser or LED-illuminated system for generation of simple alphanumeric information such as, for example, could be used for displaying speed or altitude information. The lens system is chosen to present the object in the desired location of the field of view at a desired magnification.

The choice of diffraction efficiency for the grating can be important. The diffraction grating diffracts both the light coming from the illuminated object and the incoming light scene into the peripheral vision. The effects of simultaneously viewing both sources of light (the peripheral source of light and forward incoming light scene (zero degree light) can be problematic.

To minimize the effects of both sources of light, one way to manage this problem is to use a lower efficiency grating (e.g. 10% in the first order) and to increase the brightness of the object transmitter so that the intensity of the projected image is brighter than the background image. The diffraction efficiency of the diffraction grating is a parameter than can be adjusted during the manufacturing process.

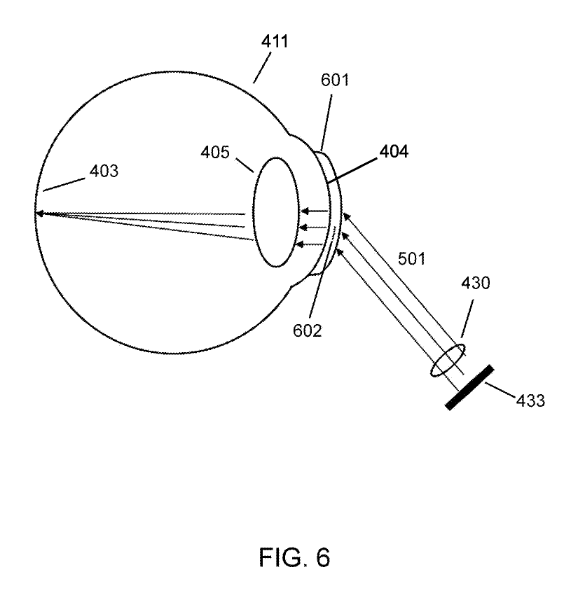

According to another way to minimize the effects of both sources of light could have other significant benefits. In this second approach, a diffraction grating is included in the contact lens that covers only part of the aperture. In this case, a reduced amount of diffraction of the visual field would be produced, whereas the reduction of intensity from the transmitter could be less, depending on the size of the projected object field. FIG. 6 shows a drawing illustrating an exemplary contact lens with a reduced size diffraction grating 602.

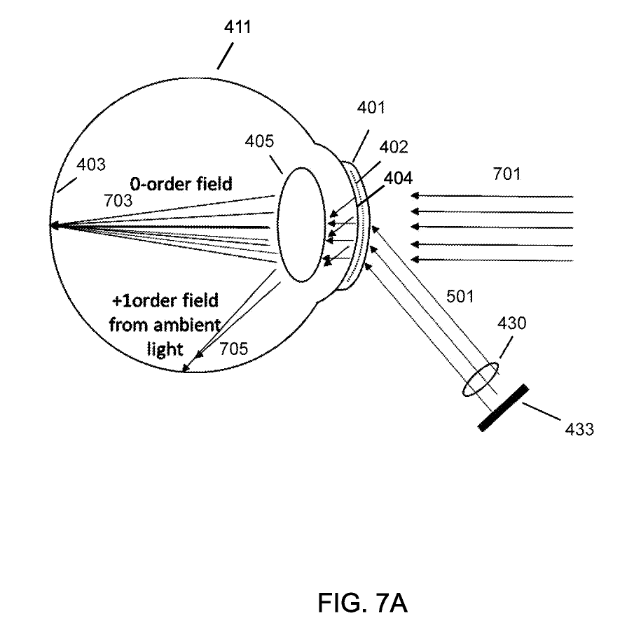

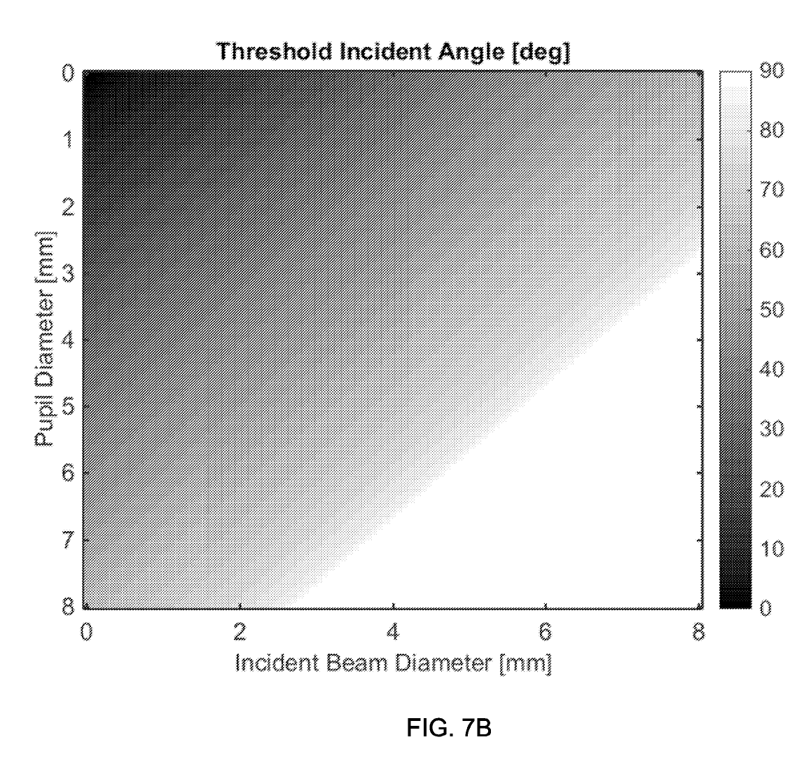

FIG. 7A is a drawing illustrating how the light from an ambient scene 701 is diffracted into the peripheral vision zone. Using either or both of the embodiments of lower grating efficiency or smaller grating size, the visible effects of this effect should be minimized.

Alignment: The use of contact lenses for the projection of the off-axis image would be subject to changes in alignment, such as when a user blinks or when the contact lens is settling into its normal position. If a user has no astigmatism, it would still be necessary to specify a contact lens that correctly orients itself through conventional mechanisms of contact lens placement and use. Typical angular fluctuations of about +5 degrees would be expected, which would cause changes in the exact location of the off-axis projected image. It is expected that such changes on the order of 5 degrees would probably be well-tolerated by most users.

In addition, the projected beam to the eye may include a 0th order of diffraction which would pass directly through the diffractive device. The input beam diameter may be selected for this beam to avoid entry of a 0th order light through the pupil and impinging on the peripheral retina.

FIG. 7B shows a graph of threshold incident angle to avoid pupil entry of 0th order beam as a function of incident beam diameter and pupil size.

Also a necessary consequence of the use of diffraction in the contact lens is the actual wavelength dependence of the diffracted angle. As discussed hereinabove, the sine of the diffracted angle varies linearly with the wavelength and inversely with the spacing of the diffraction lines. For a monochromatic object the actual wavelength dependence of the diffracted angle should be considered in the design process when choosing the diffraction angle. However, in order to project a RGB type of object into the visual field, the diffraction angles should be considered. There are several ways to determine the angles.

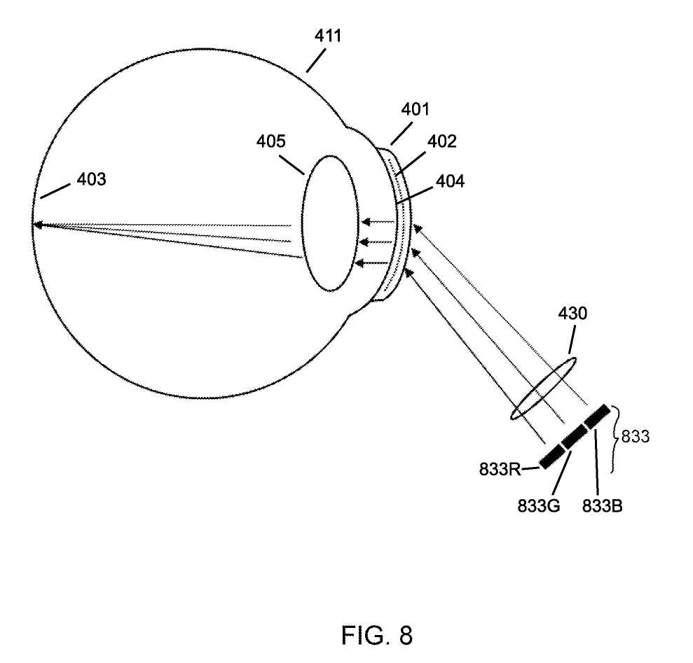

FIG. 8 shows a drawing illustrating an exemplary angularly multiplexed light source 833 that uses three separate objects, blue generator 833B, green generator 833G, and red generator 833R to produce the angularly multiplexed light source with angles that compensate the wavelength dependence of the diffraction grating in the contact lens for color.

### Example

For the case of a 0.7 micrometer spacing grating, blue light at a 400 nm wavelength would diffract at about 34 degree angle, green light at about 500 nm wavelength would diffract at about a 45 degree angle, and red light at about 600 nm wavelength would diffract at about a 59 degree angle. These angular separations are significant and provide an angular multiplexing scheme that combines the three images to produce a substantially single composite white image on the retina.

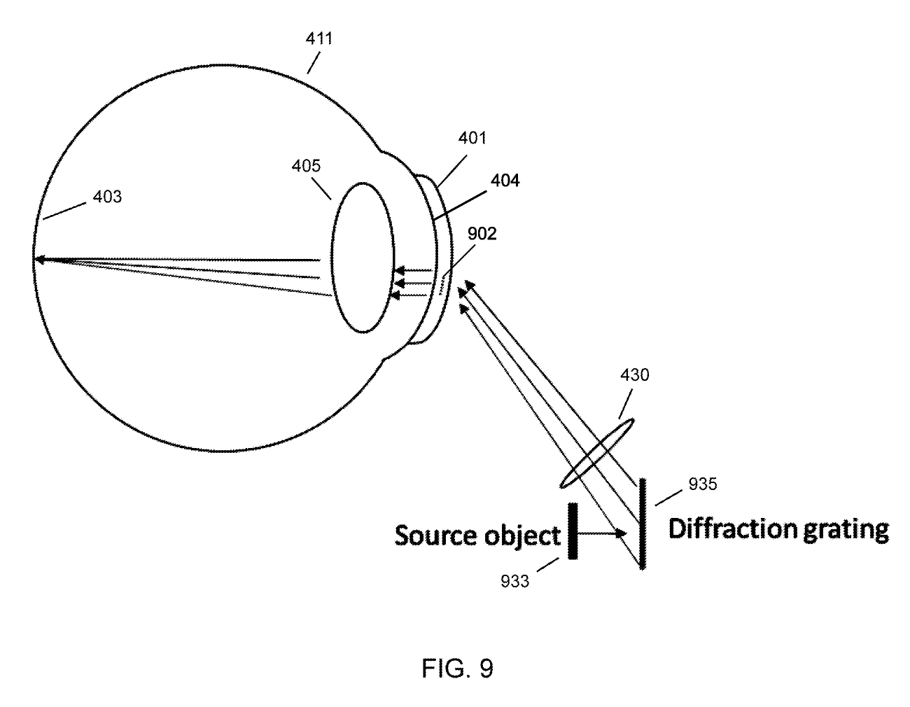

Alternatively, if a single white source object is desired, it is possible to include a diffractive device with the lens system so that the object appears to be already angularly multiplexed. Using a high efficiency grating, little light would be lost for this scheme. For example, FIG. 9 shows a drawing illustrating an exemplary white source object 933 which is angularly multiplexed by inclusion of a diffraction grating 935 into a relay lens system including lens 430.

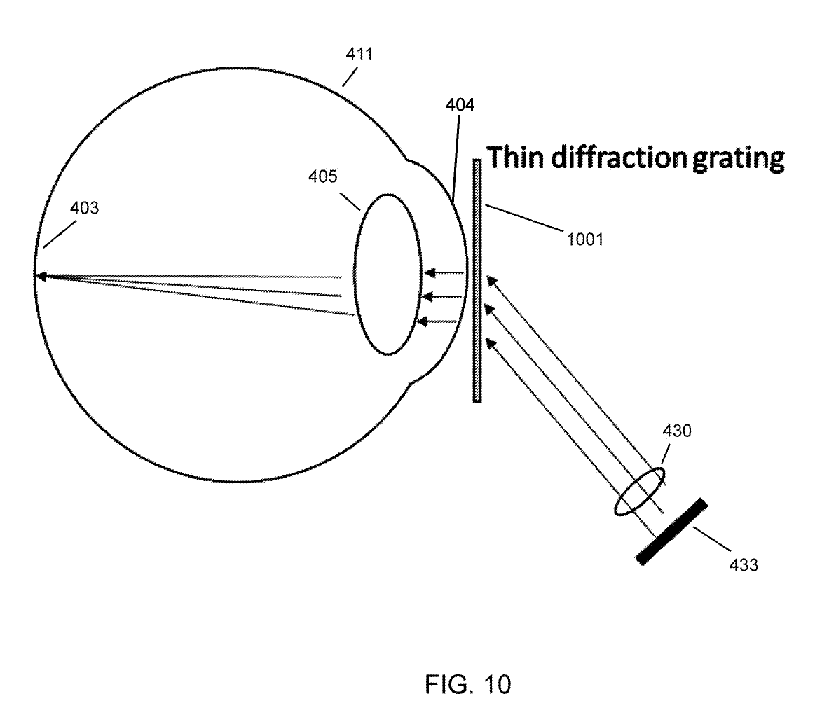

As described hereinabove, the use of contact lenses for the implementation of an optical device for off-axis viewing may be problematic for some people. In such cases, it is also contemplated that an optical device for off-axis viewing could be implemented using a conventional thin transmission grating of relatively low efficiency. For example, FIG. 10 shows one such implementation of an optical device for off-axis viewing based on a conventional thin diffraction grating placed near the cornea. However, because the diffraction grating covers the entire visual field, an implementation as shown in FIG. 10 is believed to be less desirable than other embodiments described herein.

Gratings written directly on or into the cornea of the eye: It is contemplated that there may be applications, such as, for example, to partially repair vision damaged by eye disease, where it is desirable to write a diffraction grating directly on or into the cornea of the eye.

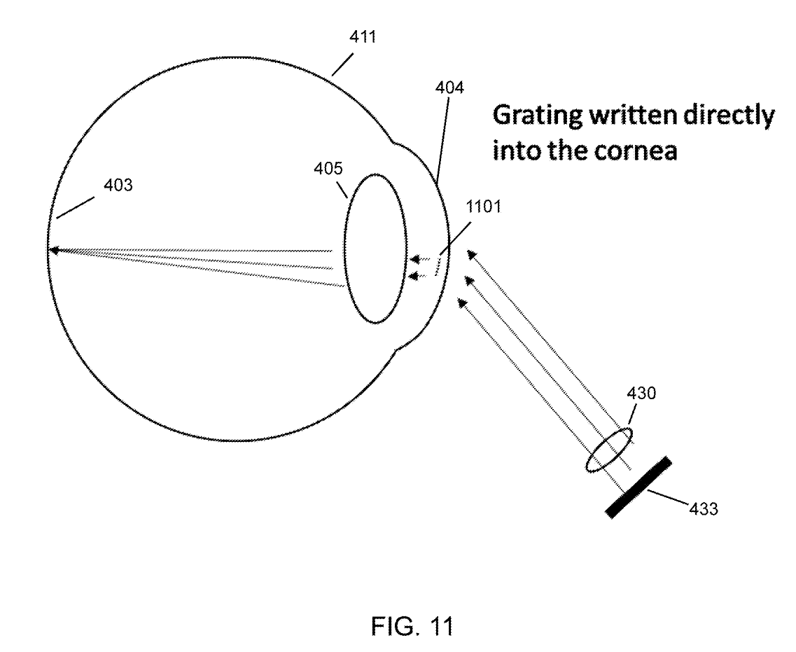

In some embodiments, a diffraction grating can be written directly into the cornea by femtosecond laser micromachining using, for example, a process referred to as Blue-IRIS, or blue intra-tissue refractive index shaping [4]. For example, FIG. 11 is a drawing illustrating a diffraction grating 1101 which is written directly into the cornea of eye 411 using Blue-IRIS [4]. A small grating so written directly into the cornea. The eye motion effects that would be present with the use of contact lenses are eliminated. The cornea grating could be large or small as discussed previously. Also, a user does not have to apply a contact lens in order to use the viewer. Several disadvantages are also possible. For example, there could be creation of visual artifacts that are visible when not using the viewer. Also, there is potential loss of efficiency of the diffraction grating in the cornea over time due to microscopic biological effects that have not been fully investigated at this time.

The use of an external diffraction grating solves the contact lens motion problem, and does not require writing in the cornea.

Techniques of compensating for wavelength dependence issues similar to those described hereinabove can be used for all three embodiments, diffraction grating as part of a contact lens, a diffraction grating written on or into the cornea, and a separate diffraction grating in the field of view.

Solutions for eye diseases, eye injuries (as caused by eye disease) are now described.

Macular degeneration: In the case of macular degeneration, patients may experience central field loss due to a retinal scotoma encompassing the fovea [5]. In addition, stroke, brain tumor or trauma may cause hemianopia, or loss of half of the visual field [6]. Certain optical devices of the prior art are available to help mitigate these visual loss diseases [6, 7]. However, devices of the prior art typically require the patient to look in an off-axis direction, which is less desirable from an optical and cosmetic point of view. The off-axis viewing by the patient is necessary to bring the retinal image of interest onto a peripheral, functioning section of the retina.

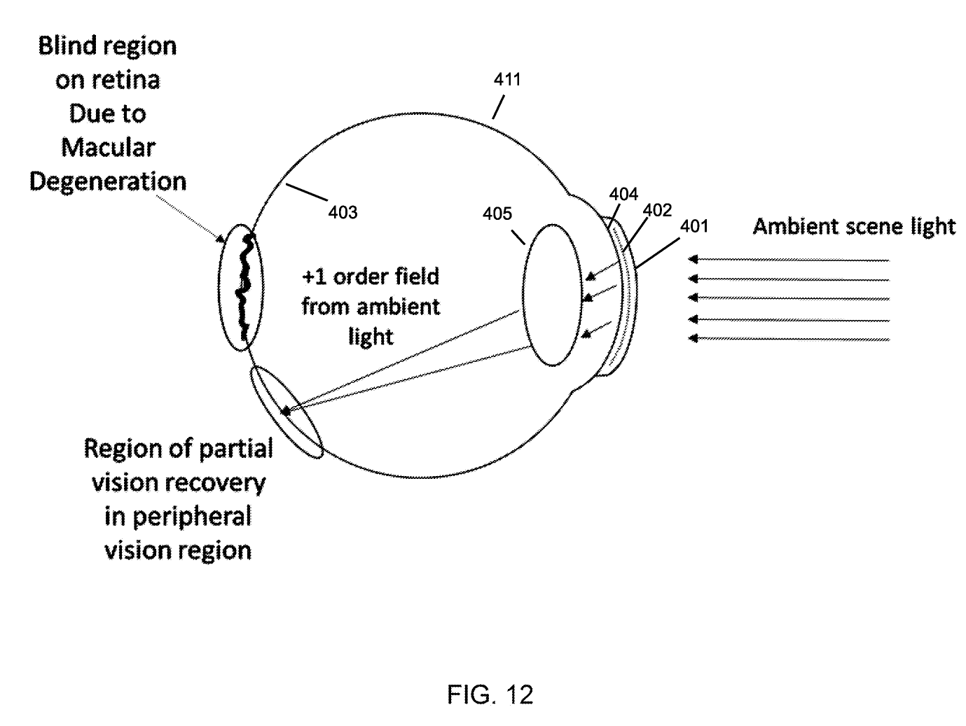

In one embodiment according to the techniques described herein, a blazed diffraction grating structure can be written so that most of the diffracted light goes into the +1 order and is directed to the peripheral vision zone, custom designed for the preferred locus of the patient. FIG. 12 shows a drawing that illustrates the use of a first order diffraction grating written into an exemplary custom contact lens to provide partial vision recovery for a patient suffering from macular degeneration. The grating is designed so that most of the light goes into the +1 diffraction order. Residual light in the zero order would not be detected.

A further customized multifocal contact lens is contemplated wherein severely myopic children (ages 10 or less, prevalent in Asia [8]) can be fitted with a specific kind of device. This device will use diffraction to induce a multifocality at the periphery of the pupil. Thereby, the peripheral pupil will experience an increase in optical power, correcting the relative peripheral hyperopia found in many progressing myopes [8]. The peripheral retinal image quality is detected by the visual system and could slow the rate of Myopic Progression [8]. The diffraction efficiency and multifocality is potentiated to fit the needs of the patient.

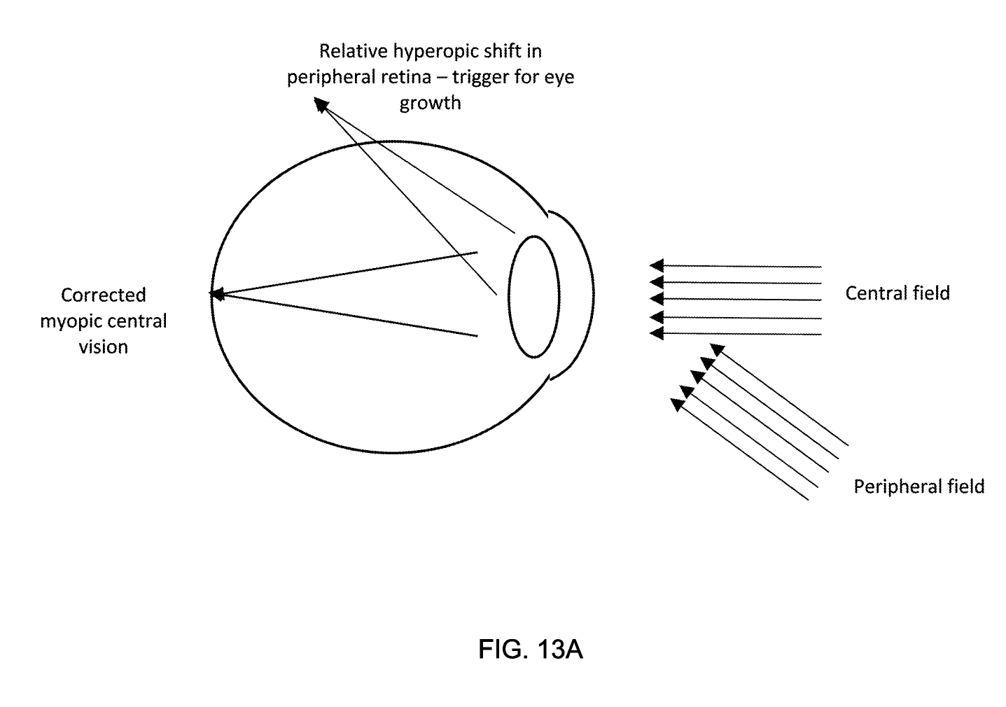

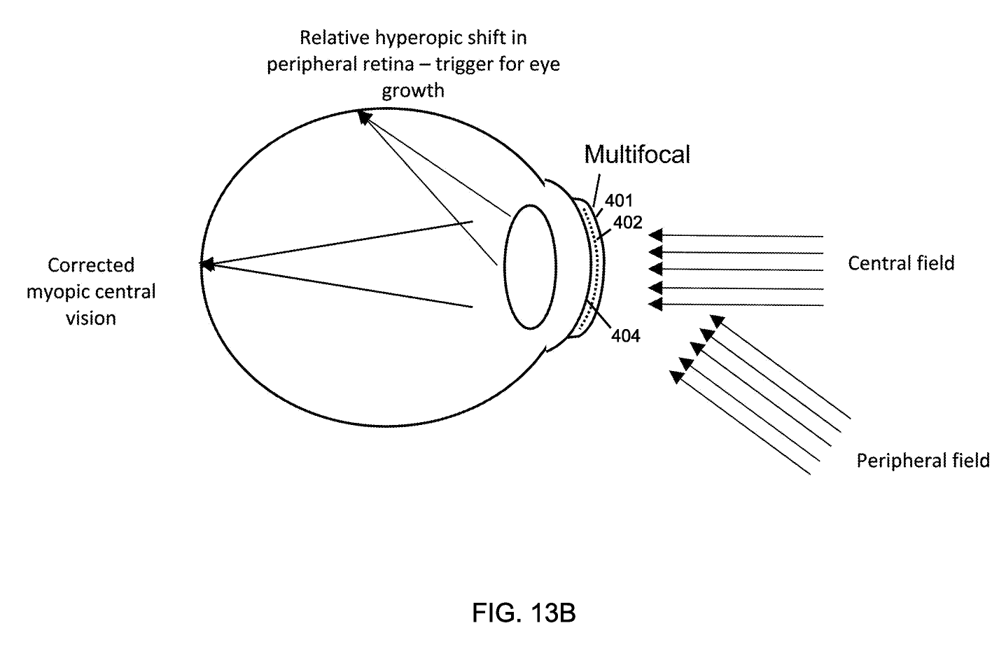

FIG. 13A shows a drawing illustrating a myopic eye with central foveal correction that is typically hyperopic in the peripheral retina. FIG. 13B shows a drawing illustrating a customized contact lens that provides vision correction across the visual field, in the central fovea as well as the peripheral retina, which may slow the progression of myopia.

In contact lens applications where the diffraction grating provides myopic central vision correction or a hyperopic shift correction across a peripheral area of the retina, a free floating contact lens might float around in angular rotation which could cause negative physiological reactions such as disorientation or dizziness. Therefore in some embodiments, the contact lens should be ballasted or stabilized on the eye by any other suitable angular alignment method.

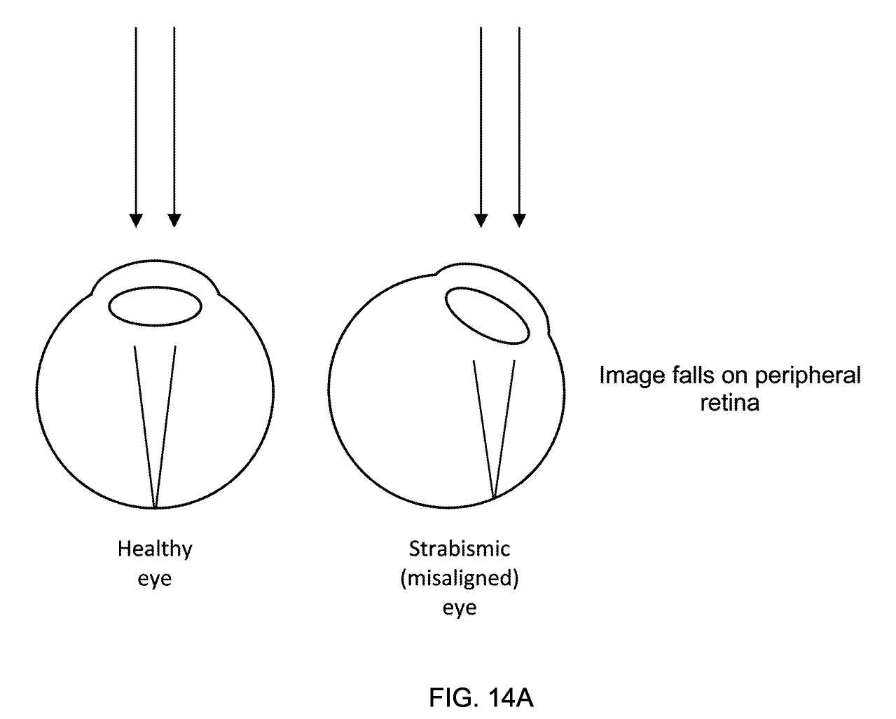

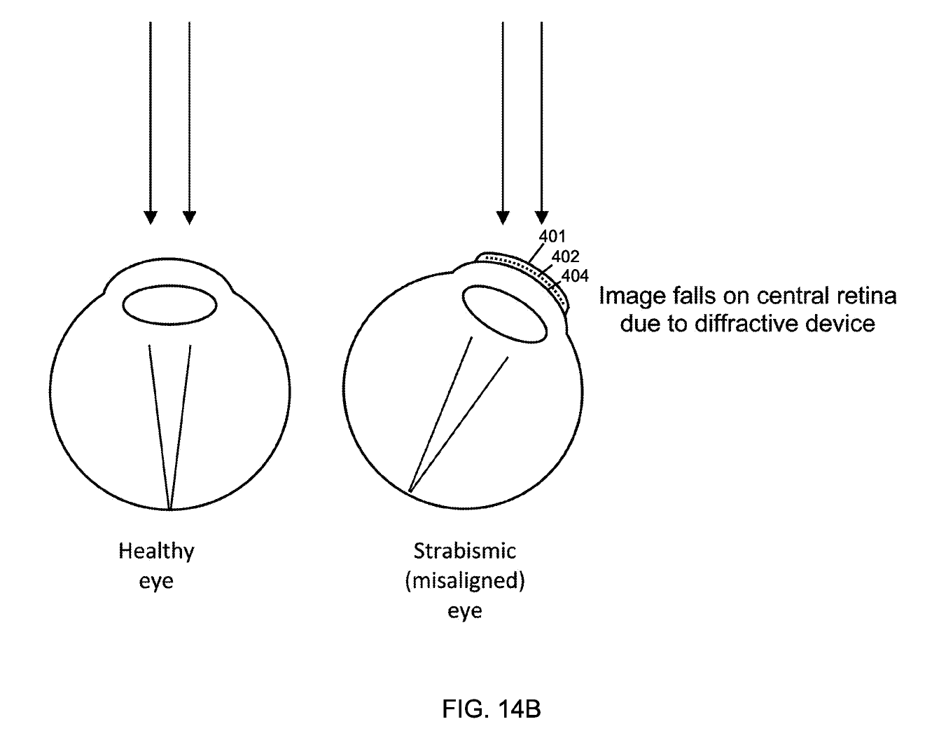

FIG. 14A shows a drawing of a healthy eye and a strabismic (misaligned eye) illustrating how in the misaligned eye, the image falls on the peripheral retina. In the case of strabismus (“lazy eye”), the extraocular muscles misalign the gaze of the affected eye, such that binocular fusion is disrupted, as shown in FIG. 14A. If untreated in children, this may lead to amblyopia, a form of cortical blindness. FIG. 14B shows a drawing of a healthy eye and a strabismic (misaligned eye) illustrating how in the misaligned eye, the image corrected by a contact lens having an integral diffraction grating now falls on the retina. The image has been redirected by the diffraction grating of the contact lens so that the light falls on the retina as light would fall on the retina of normal healthy eye. To treat ocular misalignments associated with strabismus and ocular misalignments, it is contemplated that a diffractive device as described hereinabove can be used to bring the intended visual field onto the foveal central retina, as shown in FIG. 14B.

Methods and techniques related to Blue-IRIS, or blue intra-tissue refractive index shaping have also been described, for example, in U.S. Pat. No. 7,789,910 B2, OPTICAL MATERIAL AND METHOD FOR MODIFYING THE REFRACTIVE INDEX, to Knox, et. al.; U.S. Pat. No. 8,337,553 B2, OPTICAL MATERIAL AND METHOD FOR MODIFYING THE REFRACTIVE INDEX, to Knox, et. al.; U.S. Pat. No. 8,486,055 B2, METHOD FOR MODIFYING THE REFRACTIVE INDEX OF OCULAR TISSUES, to Knox, et. al.; U.S. Pat. No. 8,512,320 B1, METHOD FOR MODIFYING THE REFRACTIVE INDEX OF OCULAR TISSUES, to Knox, et. al.; and U.S. Pat. No. 8,617,147 B2, METHOD FOR MODIFYING THE REFRACTIVE INDEX OF OCULAR TISSUES. All of the above named patents, including the '910, '553, '055, '320, and '147 patents are incorporated herein by reference in their entirety for all purposes.

Exemplary systems and methods suitable for writing gratings into contact lenses or the cornea of an eye are described the above named patents, including the '910, '553, '055, '320, and '147 patents.

For example, the Blue-IRIS method as described in the '147 patent, is typically performed using a pulsed laser, such as a femtosecond laser. One exemplary method for forming a refractive structure in a living eye, includes: (a) directing and focusing a plurality of femtosecond laser pulses in a spectral region from between 350 nanometers (nm) to 600 nm within a cornea or a lens of the living eye; b) controlling the intensity of the laser pulses to have an intensity sufficient to change the refractive index of the cornea or lens within a defined focal region, but below a damage threshold the cornea or lens, or at a level that will not photo-disrupt cornea or lens tissue outside of the focal region; and (c) forming a refractive structure in the focal region of the cornea or the lens by scanning the laser pulses through a volume of the cornea or the lens.

In some embodiments, the method further includes creating a difference in the refractive index of the refractive structure in the cornea or lens from that outside of the focal region by between about 0.005 to 0.06. In another embodiment, the method further includes forming the refractive structure having no scattering of visible light. In yet another embodiment, the refractive structure has structural forms of at least one of a lens, a prism, a Bragg grating, a microlens arrays, a zone plate, a Fresnel lenses, and a combination thereof. In another embodiment, the method further includes measuring the degree of vision correction needed by a patient following cataract surgery prior to step (a), and determining the location and shape of the refractive structure to be formed within the cornea so as to improve or correct the patient's vision. In another embodiment, the method further includes measuring the degree of vision correction needed by a patient prior to step (a), and determining the location and shape of the refractive structure to be positioned within the cornea or lens to improve or correct the patient's vision. In another embodiment, the femtosecond laser pulses have a repetition rate from 10 MHz to 300 MHz, and a pulse duration of 30 fs to 200 fs. In another embodiment, the femtosecond laser pulses have an average power from about 20 mW to 160 mW. In another embodiment, the femtosecond laser pulses have a pulse energy from about 0.01 nJ to 10 nJ. In another embodiment, the pulse energy is from about 0.1 nJ to 2 nJ. In another embodiment, the focal region is the form of cylindrical volumes from about 0.5 μm to 3 μm in diameter and 3 μm to 10 μm in length. In another embodiment, the defined focal region is in the form of a cylindrical volume having a diameter between 1.0 μm to 2 μm and a length between about 3 μm to 6 μm. In another embodiment, directing and focusing the femtosecond laser pulses within the cornea of the living eye further includes minimizing cell deaths in the stroma. In another embodiment, directing and focusing the plurality of femtosecond laser pulses in a spectral region from between about 375 nm to 425 nm. In another embodiment, directing and focusing the plurality of femtosecond laser pulses in a spectral region from between about 350 nm to 400 nm. In another embodiment, measuring a degree of vision correction needed by a patient and determining a location and a shape of refractive structures within the patient's cornea to partially correct the patient's vision. In another embodiment, directing and focusing the plurality of femtosecond laser pulses in a spectral region from between about 375 nm to 425 nm. In another embodiment, directing and focusing the plurality of femtosecond laser pulses in a spectral region from between about 350 nm to 400 nm.

Any software and/or firmware used to control lasers that write a diffraction grating on or into a contact lens or human eye as described hereinabove can be provided on a computer readable non-transitory storage medium. A computer readable non-transitory storage medium as non-transitory data storage includes any data stored on any suitable media in a non-fleeting manner Such data storage includes any suitable computer readable non-transitory storage medium, including, but not limited to hard drives, non-volatile RAM, SSD devices, CDs, DVDs, etc.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

### REFERENCES

[1] U.S. Patent Application Publication No. 2013/0070338.
[2] Li Ding, Dharmendra Jani, Jeffrey Linhardt, Jay F. Kunzler, Siddhesh Pawar, Glen Labenski, Thomas Smith, and Wayne H. Knox, “Large enhancement of femtosecond laser micromachining speed in dye-doped hydrogel polymers,” Optics Express, Vol. 16, Issue 26, pp. 21914-21921 (December 2008).
[3] “Lateral gradient index microlenses written in ophthalmic hydrogel polymers by femtosecond laser micromachining,” Lisen Xu and Wayne H. Knox, Optical Materials Express, Vol. 1, Issue 8, pp. 1416-1424 (2011)
[4] Li Ding, Wayne H Knox, Jens Buehren, Lana J Nagy, and Krystel R. Huxlin, “Intra-tissue Refractive Index Shaping (IRIS) of the cornea and lens using a low-pulse-energy femtosecond laser oscillator”, Invest. Ophthalmol. Vis. Sci. Jul. 18, 2008
[5] P. Matthew Bronstad, Alex R. Bowers, Amanda Albu, Robert Goldstein, Eli Peli, “Driving with Central Field Loss I”, JAMA Ophthalmol. 131(3), 2013.
[6] Eli Peli, “Vision Multiplexing: an optical engineering concept for low-vision aids”, Proc. of SPIE, vol. 6667, 2007.
[7] Hudson, Henry L., Stephen S. Lane, Jeffrey S. Heier, R. Doyle Stulting, Lawrence Singerman, Paul R. Lichter, Paul Sternberg, and David F. Chang. “Implantable miniature telescope for the treatment of visual acuity loss resulting from end-stage age-related macular degeneration: 1-year results.” Ophthalmology 113, no. 11 (2006): 1987-2001.
[8] Chen-Wei Pen, Dharani Ramamurthy, Seang-Mei Saw, “Worldwide prevalence and risk factors for myopia”, Ophthalmic and Physiological Optics, 32, 2012.
[9] Sankaridurg, Padmaja, Brien Holden, Earl Smith, Thomas Naduvilath, Xiang Chen, Percy Lazon de la Jara, Aldo Martinez et al. “Decrease in rate of myopia progression with a contact lens designed to reduce relative peripheral hyperopia: one-year results.” Investigative ophthalmology & visual science 52, no. 13 (2011): 9362-9367.

What is claimed is:

1. An optical device for off-axis viewing comprising:
a contact lens adapted for human eye wear, said contact lens comprising a diffraction grating written into or on said contact lens;
wherein a peripheral light from a peripheral light source is diffracted by said diffraction grating so as to appear at about a same location as light from an ambient scene substantially in a direction of a central field of view; and
wherein a wearer of said optical device for off-axis viewing sees simultaneously, said peripheral light and said light from an ambient scene as superimposed at least in part over each other.

2. The optical device of claim 1, wherein said peripheral light from a peripheral light source comprises a substantially monochromatic light.

3. The optical device of claim 1, wherein said peripheral light from a peripheral light source comprises a light of at least two or more different colors.

4. The optical device of claim 3, further comprising a color multiplexing technique to combine different colors of said peripheral light into a color corrected image.

5. The optical device of claim 4, wherein said color multiplexing technique comprises at least two different color light generators spaced apart from each other.

6. The optical device of claim 4, wherein said color multiplexing technique further comprises disposed between said peripheral light source and said contact lens a second corrective diffraction grating and lens.

7. The optical device of claim 1, wherein an area of said diffraction grating written on or into said contact lens determines an intensity of said peripheral light directed onto a retina of said eye.

8. The optical device of claim 1, wherein a diffraction grating efficiency of said diffraction grating written on or into said contact lens determines an intensity of said peripheral light directed onto a retina of said eye.

9. A device-less method for correcting light direction from an ambient light source to a retina of a diseased or injured eye comprising:
providing a laser scanning system configured to write a diffraction grating on or into a cornea of a human eye; and
writing a diffraction grating of grating length defined by a number of written grating lines, grating width defined by a laser scanning distance, and a diffraction grating wavelength dependence defined by a grating line spacing on or in a cornea of said human eye.

10. The method of claim 9, wherein said step of writing comprises writing a diffraction grating directly into said cornea by use of a pulsed laser micromachining.

11. The method of claim 10, wherein said pulsed laser micromachining comprises about 400 nm wavelength high repetition rate about 100 fs width pulses.

12. The method of claim 9, wherein said eye comprises an eye affected by an eye disease or injury to the eye, and said diffraction grating redirects an ambient light received by said eye to a another part of a retina of said eye to mitigate symptoms of said eye disease or injury.

13. The method of claim 12, wherein said ambient light from a blind region of said retina is redirected by said diffraction grating to a region of at least partial vision in what would otherwise in an absence of the diffraction grating, be a peripheral vision region of the retina.

14. The method of claim 12, wherein said diffraction grating provides myopic central vision correction or a hyperopic shift correction across a peripheral area of said retina.

15. The method of claim 12, wherein said diffraction grating causes said ambient light entering a strabismic or misaligned eye to fall about on a central region of the retina or in the fovea region.

16. A remedial contact lens method for correcting light direction from an ambient light source to a retina of a diseased or injured eye comprising:
providing a laser system configured to write a diffraction grating on or into a contact lens of human eye, said contact lens having a corrective physical and optical shape tailored to said eye; and
writing a diffraction grating of grating length defined by a number of written grating lines, grating width defined by a laser scanning distance, and diffraction grating wavelength dependence defined by a grating line spacing on or into a said contact lens; and
wearing said contact lens comprising said diffraction grating.

17. The method of claim 16, wherein said step of writing comprises writing a diffraction grating directly into said contact lens by use of a femtosecond laser micromachining.

18. The method of claim 17, wherein said step of writing comprises about 400 nm wavelength high repetition rate about 100 fs width pulses.

19. The method of claim 16, wherein said human eye comprises an eye affected by an eye disease or injury to the eye, and said diffraction grating redirects an ambient light received by said eye to a another part of a retina of said eye to mitigate symptoms of said eye disease or injury.

20. The method of claim 16, wherein said ambient light from a blind region of said retina is redirected by said diffraction grating to a region of at least partial vision in what would otherwise in an absence of the diffraction grating, be a peripheral vision region of the retina.

21. The method of claim 16, wherein said diffraction grating provides a myopic central vision correction or a hyperopic shift correction across a peripheral area of said retina.

22. The method of claim 16, wherein said diffraction grating causes said ambient light entering a strabismic or misaligned eye to fall about on a central region of the retina or in the fovea region.
